(19) United States
(12) Patent Application Publication
(10) Pub. No.: US 2026/0113591 A1
(43) Pub. Date: Apr. 23, 2026

(54) METHOD FOR MATCHING LEFT AND RIGHT CHANNELS OF EARPHONE, AND CLIP-ON EARPHONE AND STORAGE MEDIUM

(71) Applicant: GOERTEK INC., Weifang (CN)

(72) Inventors: Haiyong WANG, Weifang (CN); Bin JIANG, Weifang (CN)

(21) Appl. No.: 19/404,590

(22) Filed: Dec. 1, 2025

Related U.S. Application Data
(63) Continuation of application No. PCT/CN2025/084583, filed on Mar. 25, 2025.

(30) Foreign Application Priority Data
Mar. 28, 2024 (CN) 202410370215.6

(51) Int. Cl. H04S 7/00; H04R 1/10; H04R 5/04; H04R 29/00

(52) U.S. Cl. CPC H04S 7/304; H04R 1/1091; H04R 5/04; H04R 29/001; H04R 2201/109; H04R 2460/15

(57) ABSTRACT

A method for matching left and right channels of an earphone, a clip-on earphone, and a computer-readable storage medium. The method includes: acquiring three-axis acceleration information detected by a three-axis acceleration sensor and detection distance information detected by an infrared distance sensor when it is detected that the target earphone is completely worn, where the target earphone is the first earphone or the second earphone of the clip-on earphone; adjusting the channel of the speaker of the target earphone according to the three-axis acceleration information and the detection distance information, so that the channel of the target earphone matches the wearing position.

### CROSS-REFERENCE TO RELATED APPLICATIONS

This application is a continuation application of International Application No. PCT/CN2025/084583, filed on Mar. 25, 2025, which claims priority to Chinese Patent Application No. 202410370215.6, filed on Mar. 28, 2024. All of the aforementioned applications are incorporated herein by reference in their entireties.

### TECHNICAL FIELD

The present application relates to the technical field of earphones, and in particular relates to a method for matching left and right channels of an earphone, a clip-on earphone, and a storage medium.

### BACKGROUND

With the development of new technologies, open wearable stereo (OWS) earphones such as clip-on earphones have become increasingly popular. Compared with true wireless stereo (TWS) earphones, clip-on earphones are friendly to the ears, do not damage hearing, are comfortable to wear, and are more beneficial for long-term wearing. Clip-on OWS earphones, which do not require in-ear wearing, can have a consistent left-right structure and universal wearing, differing from traditional earphones.

A clip-on earphone includes a left earphone and a right earphone, where the left earphone fixedly outputs the left channel and the right earphone fixedly outputs the right channel. When the stereo earphone is worn on the user's ears, the left earphone is in contact with the user's left ear and the right earphone is in contact with the user's right ear, so that the left ear receives the left channel and the right ear receives the right channel. During wearing, the relative positions of the left earphone and the right earphone cannot be swapped; otherwise, the fidelity of the sound source and the resolution of audio frequencies will be directly affected.

To achieve an optimal sound quality output effect, the user must confirm the left and right sides before wearing the clip-on earphone. The current solution is to mark identifiers such as L/R on the clip-on earphone, but this requires manual confirmation to avoid wearing the earphones in reverse, which brings inconvenience to the user.

### SUMMARY

The main purpose of the present application is to provide a method for matching left and right channels of an earphone, a clip-on earphone, and a storage medium, aiming to solve the technical problem in the related art that manual confirmation of whether the left and right earphones are worn in reverse is required, resulting in poor usability of the clip-on earphone.

To achieve the above purpose, the present application provides a method for matching left and right channels of an earphone, applied to a clip-on earphone. A target earphone of the clip-on earphone is provided with a three-axis acceleration sensor, and infrared distance sensors are provided at a first position and a second position in a speaker compartment area of the target earphone, the first position is opposite to the second position, the method includes:
acquiring three-axis acceleration information detected by the three-axis acceleration sensor and detection distance information detected by the infrared distance sensor when it is detected that the target earphone is completely worn, where the target earphone is the first earphone or the second earphone of the clip-on earphone; and
adjusting a channel of a speaker of the target earphone according to the three-axis acceleration information and the detection distance information, to make the channel of the target earphone match a wearing position.

In an embodiment, the adjusting the channel of the speaker of the target earphone according to the three-axis acceleration information and the detection distance information includes:
determining the wearing position corresponding to the target earphone according to the three-axis acceleration information and the detection distance information; and
adjusting the channel of the speaker of the target earphone based on the wearing position corresponding to the target earphone, to make a left channel correspond to the earphone at a left ear wearing position, and/or a right channel correspond to the earphone at a right ear wearing position.

In an embodiment, the determining the wearing position corresponding to the target earphone according to the three-axis acceleration information and the detection distance information includes:
determining a component direction of the three-axis acceleration information in a vertical direction;
determining a first distance detected by the infrared distance sensor at the first position and a second distance detected by the infrared distance sensor at the second position;
determining wearing posture information corresponding to the target earphone according to the first distance, the second distance, and the component direction; and
determining the wearing position corresponding to the target earphone according to the wearing posture information.

In an embodiment, the determining the wearing posture information corresponding to the target earphone according to the first distance, the second distance, and the component direction includes:
in response to that the first distance is greater than the second distance and the component direction of the three-axis acceleration information in the vertical direction is a positive Z-axis direction, determining that the wearing posture information corresponding to the target earphone is the first posture; and
in response to that the first distance is less than the second distance and the component direction of the three-axis acceleration information in the vertical direction is a negative Z-axis direction, determining that the wearing posture information corresponding to the target earphone is the second posture.

In an embodiment, the method further includes:
in response to that the first distance is less than the second distance and the component direction of the three-axis acceleration information in the vertical direction is the positive Z-axis direction, or in response to that the first distance is greater than the second distance and the component direction of the three-axis acceleration information in the vertical direction is the negative Z-axis direction, determining a component value of the three-axis acceleration information in the vertical direction; and
determining the wearing posture information corresponding to the target earphone according to the component direction and the component value.

In an embodiment, the determining the wearing posture information corresponding to the target earphone according to the component direction and the component value includes:
in response to that the component direction of the three-axis acceleration information in the vertical direction is the positive Z-axis direction and the component value matches gravitational acceleration value, determining that the wearing posture information corresponding to the target earphone is the first posture; and
in response to that the component direction of the three-axis acceleration information in the vertical direction is the negative Z-axis direction and the component value matches the gravitational acceleration value, determining that the wearing posture information corresponding to the target earphone is the second posture.

In an embodiment, after the determining the component value of the three-axis acceleration information in the vertical direction, the method further includes:
in response to that the component value matches the gravitational acceleration value, executing the step of determining the wearing posture information corresponding to the target earphone according to the component direction and the component value;
in response to that the component value does not match the gravitational acceleration value, determining the wearing posture information corresponding to a reference earphone; and
determining the wearing posture information corresponding to the target earphone according to the wearing posture information corresponding to the reference earphone, where the reference earphone is the earphone of the other channel corresponding to the target earphone in the clip-on earphone.

In an embodiment, the determining the wearing posture information corresponding to the target earphone according to the wearing posture information corresponding to the reference earphone includes:
in response to that the wearing posture information corresponding to the reference earphone is the second posture, determining that the wearing posture information corresponding to the target earphone is the first posture; and
in response to that the wearing posture information corresponding to the reference earphone is the first posture, determining that the wearing posture information corresponding to the target earphone is the second posture.

In an embodiment, the determining the wearing position corresponding to the target earphone according to the wearing posture information includes:
in response to that the wearing posture information is the first posture, determining that the wearing position corresponding to the target earphone is the left ear wearing position; and
in response to that the wearing posture information is the second posture, determining that the wearing position corresponding to the target earphone is the right ear wearing position.

In an embodiment, the first position is an upper end position of the speaker compartment when the target earphone is in a worn state, and a detection direction of the infrared distance sensor provided at the first position is upward detection; and the second position is a lower end position of the speaker compartment when the target earphone is in the worn state, and the detection direction of the infrared distance sensor provided at the second position is downward detection.

The present application further provides a clip-on earphone, which is a physical device. The clip-on earphone includes a memory; a processor; a behind-ear compartment; a speaker compartment; and a connecting bridge connecting the behind-ear compartment and the speaker compartment, where the speaker compartment is provided with an acoustic module and an infrared distance sensor, the acoustic module includes a speaker, and the behind-ear compartment is provided with a power module and an acceleration sensor;
the power module is configured for providing electric energy for the clip-on earphone;
the acceleration sensor is configured for detecting three-axis acceleration information of the clip-on earphone;
the infrared distance sensor is configured for detecting detection distance information;
the memory is configured for storing an earphone left-right channel matching program; and
the processor is configured for executing the earphone left-right channel matching program, and when executing the earphone left-right channel matching program, implementing the method for matching left and right channels of the earphone as described above.

The present application further provides a computer-readable storage medium storing a program implementing the method for matching the left and right channels of the earphone. The program is executed by a processor to implement the method for matching left and right channels of the earphone as described above.

The present application further provides a computer program product, including a computer program that, when executed by a processor, implements the method for matching left and right channels of the earphone as described above.

The present application discloses the method for matching left and right channels of the earphone, a clip-on earphone, and a storage medium. The method for matching left and right channels of the earphone is applied to the clip-on earphone. A target earphone of the clip-on earphone is provided with a three-axis acceleration sensor, and infrared distance sensors are provided at a first position and a second position in the speaker compartment area of the target earphone, where the first position and the second position are opposite to each other. The technical solution of the method for matching left and right channels of the earphone of the present application is: when it is detected that the target earphone is completely worn, acquire three-axis acceleration information detected by the three-axis acceleration sensor and detection distance information detected by the infrared distance sensor (where the target earphone is the first earphone or the second earphone of the clip-on earphone), and adjust the channel of the speaker of the target earphone according to the three-axis acceleration information and the detection distance information, so that the channel of the target earphone matches the wearing position. This ensures that the left channel corresponds to the earphone at the left ear wearing position and the right channel corresponds to the earphone at the right ear wearing position, thereby realizing automatic matching between left-right channels and left-right ears. This overcomes the inconvenience in the related art where identifiers such as L/R are marked on earphones and manual confirmation is required to avoid wearing them in reverse, improving the usability of the clip-on earphone. It effectively enables users to avoid distinguishing left-right channels before wearing the earphones; that is, no matter how the clip-on earphone is worn, the sound signals of the left and right channels received are always correct, enhancing the user's listening experience.

### BRIEF DESCRIPTION OF THE DRAWINGS

The accompanying drawings incorporated in and constituting a part of this specification illustrate embodiments consistent with the present application and together with the description explain the principles of the present application.

To more clearly illustrate the embodiments or the technical solutions in the prior art, the following will briefly introduce the drawings needed in the description of the embodiments or the prior art. Obviously, for those of ordinary skill in the art, other drawings can be obtained according to these drawings without creative labor.

FIG. 1 is a schematic flow chart of a method for matching left and right channels of an earphone according to an embodiment of the present application.

FIG. 2 is a schematic flow chart of a method for matching left and right channels of an earphone according to an embodiment of the present application.

FIG. 3 is a schematic flow chart of a method for matching left and right channels of an earphone according to an embodiment of the present application.

FIG. 4 is a schematic flow chart of a method for matching left and right channels of an earphone according to an embodiment of the present application.

FIG. 5 is a schematic flow chart of a method for matching left and right channels of an earphone according to an embodiment of the present application.

FIG. 6 is a schematic flow chart of a method for matching left and right channels of an earphone according to an embodiment of the present application.

FIG. 7 is a schematic flow chart of a method for matching left and right channels of an earphone according to an embodiment of the present application.

FIG. 8 is a schematic flow chart of a method for matching left and right channels of an earphone according to an embodiment of the present application.

FIG. 9 is a schematic flow chart of a method for matching left and right channels of an earphone according to an embodiment of the present application.

FIG. 10 is a schematic flow chart of a method for matching left and right channels of an earphone according to an embodiment of the present application.

FIG. 11 is a schematic diagram of a wearing posture of a clip-on earphone according to an embodiment of the present application in a worn state from one view.

FIG. 12 is a view of the clip-on earphone from one perspective according to an embodiment of the present application.

FIG. 13 is a schematic diagram of the arrangement of infrared distance sensors according to an embodiment of the present application.

FIG. 14 is a diagram showing three-axis acceleration information when clip-on earphones are worn on the left ear and right ear according to an embodiment of the present application.

FIG. 15 is a schematic diagram of an infrared distance detection scenario when the target earphone is in a worn state in an example of the present application.

The realization of the objectives, functional features, and advantages of the present application will be further described with reference to the embodiments and the accompanying drawings.

### DETAILED DESCRIPTION OF THE EMBODIMENTS

To make the above objectives, features, and advantages of the present application more obvious and understandable, the technical solutions in the embodiments of the present application will be clearly and completely described below with reference to the accompanying drawings in the embodiments of the present application. Obviously, the described embodiments are only a part of the embodiments of the present application, not all of them. Based on the embodiments of the present application, all other embodiments obtained by those of ordinary skill in the art without creative labor fall within the protection scope of the present application.

A clip-on earphone includes a left earphone and a right earphone, where the left earphone fixedly outputs the left channel and the right earphone fixedly outputs the right channel. When the stereo earphone is worn on the user's ears, the left earphone is in contact with the user's left ear and the right earphone is in contact with the user's right ear, so that the left ear receives the left channel and the right ear receives the right channel. During wearing, the relative positions of the left earphone and the right earphone cannot be swapped; otherwise, the fidelity of the sound source and the resolution of audio frequencies will be directly affected.

To achieve an optimal sound quality output effect, the user must confirm the left and right sides before wearing the clip-on earphone. The current solution is to mark identifiers such as L/R on the clip-on earphone, but this requires manual confirmation to avoid wearing the earphones in reverse, which brings inconvenience to the user.

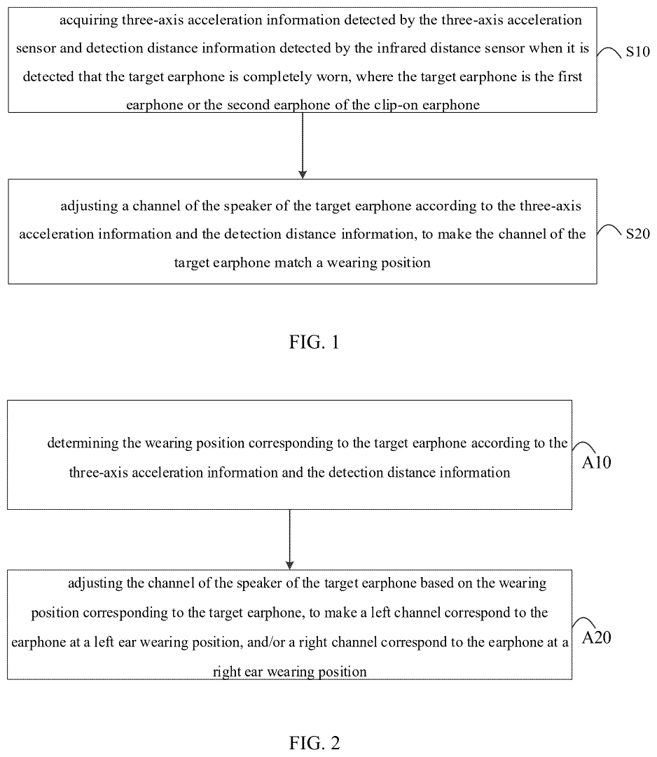

Based on this, as shown in FIG. 1. FIG. 1 is a schematic flow chart of a method for matching left and right channels of an earphone according to an embodiment of the present application. The method for matching left and right channels of the earphone is applied to a clip-on earphone. A target earphone of the clip-on earphone is provided with a three-axis acceleration sensor, and infrared distance sensors are provided at a first position and a second position in the speaker compartment area of the target earphone, where the first position and the second position are arranged opposite to each other. The method includes:
Step S10: acquiring three-axis acceleration information detected by the three-axis acceleration sensor and detection distance information detected by the infrared distance sensor when it is detected that the target earphone is completely worn, where the target earphone is the first earphone or the second earphone of the clip-on earphone;

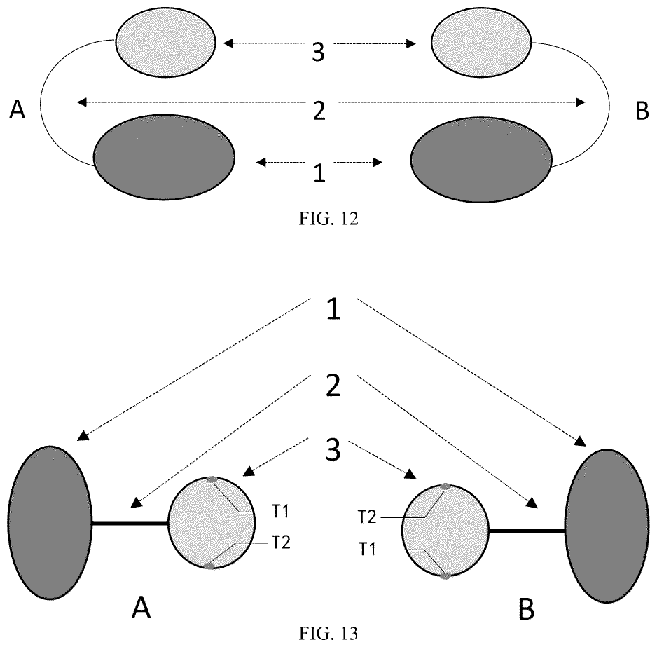

It is known to those skilled in the art that the clip-on earphone includes two individual earphones, i.e., the first earphone and the second earphone. As shown in FIG. 12, FIG. 12 is a view of the clip-on earphone from one perspective according to an embodiment of the present application. One individual earphone includes a speaker compartment 3, a behind-ear compartment 1, and a connecting bridge 2 connecting the speaker compartment and the behind-ear compartment. The “speaker compartment area” refers to the area corresponding to the speaker compartment 3. It is known to those skilled in the art that for a clip-on earphone, the speaker compartment 3 is generally provided with an acoustic module, which includes a speaker; of course, the acoustic module may also include a microphone, which is not specifically limited in this embodiment. The behind-ear compartment 1 is generally provided with a power module for providing electric energy; of course, the behind-ear compartment 1 may also be provided with a noise reduction module and a communication module, which are not specifically limited in this embodiment. The speaker is used for playing audio of the left channel or the right channel, and the power module is used for providing electric energy for the individual earphone. The communication module is used for information interaction between the individual earphone and other electronic devices communicatively connected to the individual earphone. The acceleration sensor is used for detecting three-axis acceleration information of the individual earphone. The microphone is used for collecting environmental audio, and the noise reduction module is used for performing adaptive noise reduction on the environmental audio collected by the microphone based on a preset noise reduction algorithm. The preset noise reduction algorithm may be an Active Noise Control (ANC) algorithm, an Environmental Noise Cancellation (ENC) algorithm, a Digital Signal Processing (DSP) algorithm, or a Clear Voice Capture (CVC) algorithm. Those skilled in the art have conducted in-depth research on these noise reduction algorithms, and details are not described herein.

In this embodiment, those skilled in the art have conducted in-depth research on the hardware principle of the infrared distance sensor, and details are not described herein.

It is known to those skilled in the art that the three-axis acceleration sensor works based on the basic principle of acceleration, and acceleration is a spatial vector.
Step S20: adjusting the channel of the speaker of the target earphone according to the three-axis acceleration information and the detection distance information, so that the channel of the target earphone matches the wearing position.

Exemplarily, as shown in FIG. 2, adjusting the channel of the speaker of the target earphone according to the three-axis acceleration information and the detection distance information includes:
Step A10: determining the wearing position corresponding to the target earphone according to the three-axis acceleration information and the detection distance information;
Step A20: adjusting the channel of the speaker of the target earphone based on the wearing position corresponding to the target earphone, to make a left channel correspond to the earphone at a left ear wearing position, and/or a right channel correspond to the earphone at a right ear wearing position.

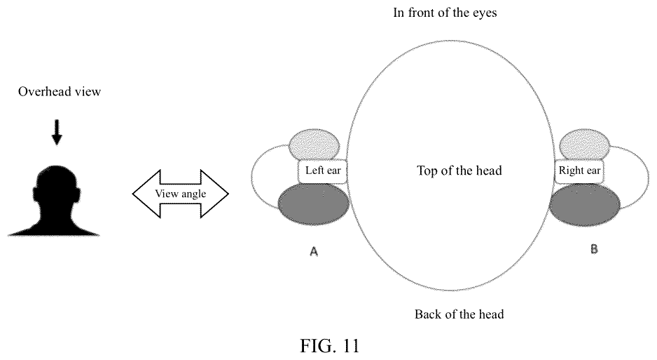

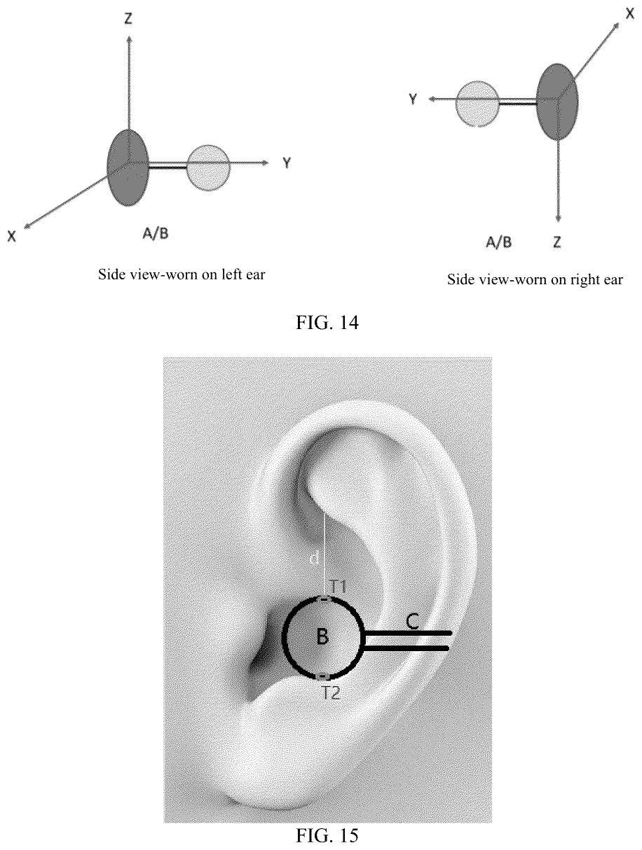

It can be understood that after the clip-on earphone is worn, the clip-on earphone has different distances from different parts of the ear (e.g., there is a contact area where the detection distance is zero, and non-contact areas also have different distances from different positions of the ear). In this embodiment, the infrared distance sensors provided in the speaker compartment area can detect distance information (i.e., distance information between the infrared distance sensors provided in the speaker compartment area and at least one part of the ear) to identify such information. Infrared distance sensors are provided at a first position and a second position in the speaker compartment area of the target earphone, and the first position and the second position are arranged opposite to each other. For ease of description, the infrared distance sensor provided at the first position is referred to as a first distance sensor, and the infrared distance sensor provided at the second position is referred to as a second distance sensor. When the target earphone is worn on the left ear instead of the right ear, its posture will be reversed. That is, if the target earphone is worn on the left ear, the first distance detected by the first distance sensor from the first ear part is a first distance, and the second distance detected by the second distance sensor from the first ear part is a second distance; then, when the target earphone is worn on the right ear, due to the reversed posture of the target earphone (by approximately 180 degrees), the distance detected by the first distance sensor from the first ear part will be converted to the second distance or approximately the second distance, and the distance detected by the second distance sensor from the first ear part will be converted to the first distance or approximately the first distance. Therefore, the change information of the detection distance of the infrared distance sensor can be used to identify the wearing posture to a certain extent, and further identify whether the earphone is worn on the left ear or the right ear through the wearing posture. As shown in FIG. 11 and FIG. 14, FIG. 11 is a schematic diagram of the wearing posture of the clip-on earphone in a worn state from one perspective, and FIG. 14 is a diagram showing three-axis acceleration information when the clip-on earphone is worn on the left and right ears according to an embodiment of the present application.

The mapping relationship between the combination of detection distance information and three-axis acceleration information and wearing position information may be pre-stored in the target earphone or in a cloud server registered and logged in with the target earphone. In an example, the mapping relationship stored in the target earphone or the cloud server registered and logged in with the target earphone is: if the first distance detected by the first distance sensor in the detection distance information falls within a first distance range, the second distance detected by the second distance sensor falls within a second distance range, and the component direction of the three-axis acceleration information in the vertical direction is the positive Z-axis direction, the corresponding wearing position information is the left ear wearing position; and if the first distance detected by the first distance sensor in the detection distance information falls within the second distance range, the second distance detected by the second distance sensor falls within the first distance range, and the component direction of the three-axis acceleration information in the vertical direction is the negative Z-axis direction, the corresponding wearing position information is the right ear wearing position. Based on the stored mapping relationship, it is convenient to determine the wearing position corresponding to the target earphone according to the detection distance information and the three-axis acceleration information. It should be noted that the first distance range is different from the second distance range.

The embodiment of the present application discloses a method for matching left and right channels of the earphone, a clip-on earphone, and a storage medium. The method for matching left and right channels of the earphone is applied to a clip-on earphone. A target earphone of the clip-on earphone is provided with a three-axis acceleration sensor, and infrared distance sensors are provided at a first position and a second position in the speaker compartment area of the target earphone, where the first position and the second position are arranged opposite to each other. The technical solution of the method for matching left and right channels of the earphone of the present application is: when it is detected that the target earphone is completely worn, acquiring three-axis acceleration information detected by the three-axis acceleration sensor and detection distance information detected by the infrared distance sensor (where the target earphone is the first earphone or the second earphone of the clip-on earphone), and adjusting the channel of the speaker of the target earphone according to the three-axis acceleration information and the detection distance information, so that the channel of the target earphone matches the wearing position. This ensures that the left channel corresponds to the earphone at the left ear wearing position and the right channel corresponds to the earphone at the right ear wearing position, thereby realizing automatic matching between left-right channels and left-right ears. This overcomes the inconvenience in the related art where identifiers such as L/R are marked on earphones and manual confirmation is required to avoid wearing them in reverse, improving the usability of the clip-on earphone. It effectively enables users to avoid distinguishing left-right channels before wearing the earphones; that is, no matter how the clip-on earphone is worn, the sound signals of the left and right channels received are always correct, enhancing the user's listening experience.

It is worth mentioning that if only the three-axis acceleration sensor is used to detect the three-axis acceleration information of the target earphone and determine the wearing position corresponding to the target earphone based on the three-axis acceleration information (e.g., if the component direction of the three-axis acceleration information in the vertical direction is the positive Z-axis direction, the wearing posture information corresponding to the target earphone is determined as the first posture; if the component direction of the three-axis acceleration information in the vertical direction is the negative Z-axis direction, the wearing posture information corresponding to the target earphone is determined as the second posture; then, if the wearing posture information is the first posture, the wearing position corresponding to the target earphone is determined as the left ear wearing position.

If the wearing posture information is the second posture, the wearing position corresponding to the target earphone is determined as the right ear wearing position), and then the left channel and right channel of the speaker of the clip-on earphone are adjusted based on the wearing positions corresponding to the first earphone and the second earphone, so that the left channel corresponds to the earphone at the left ear wearing position. However, in the process of identifying the wearing position of the target earphone only by the three-axis acceleration sensor, misjudgment may occur in some special scenarios. For example, when the user wears the earphone, the head is not in an upright position but in an inverted or lying position. In this case, the wearing position of the target earphone cannot be accurately identified; especially when the head is in an inverted position, the identified wearing position is reversed, resulting in misidentification.

Based on this, the embodiment of the present application integrates the acceleration sensor information and detection distance information of the target earphone, so that the user can complete wearing in any posture and the earphone can automatically and correctly detect the posture. The left and right ear channels will not change due to changes in the user's head movement, further improving the stability and robustness of the method for matching left and right channels of the earphone of the embodiment of the present application.

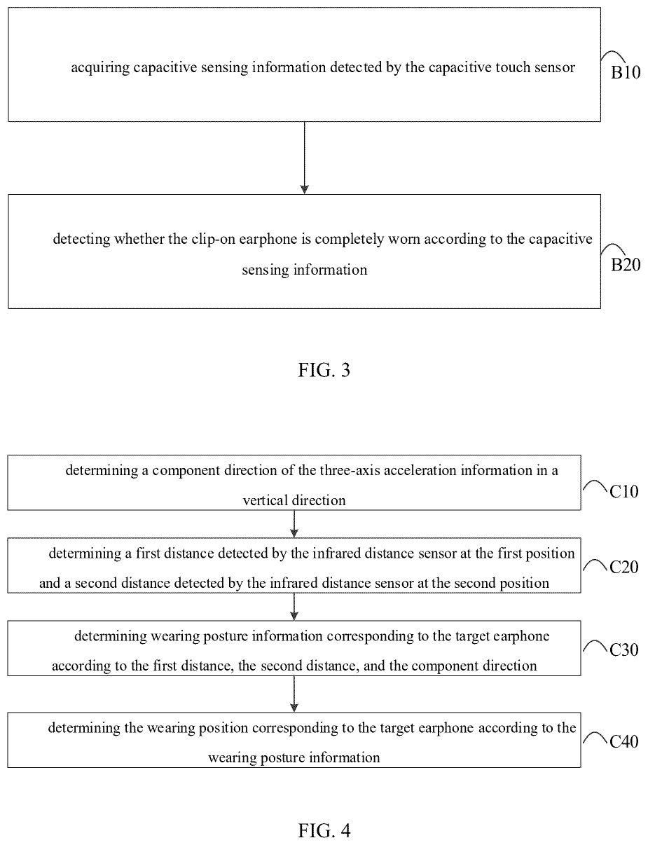

Exemplarily, as shown in FIG. 3, the first earphone and the second earphone are further provided with capacitive touch sensors, and the method further includes:
Step B10: acquiring capacitive sensing information detected by the capacitive touch sensor;
Step B20: detecting whether the clip-on earphone is completely worn according to the capacitive sensing information.

The present application acquires the capacitive sensing information detected by the capacitive touch sensor and detects whether the clip-on earphone is completely worn according to the capacitive sensing information, so as to accurately detect the wearing completion status of the clip-on earphone.

Exemplarily, the first position is the upper end position of the speaker compartment when the target earphone is in the worn state, and the detection direction of the infrared distance sensor provided at the first position is upward detection.

The second position is the lower end position of the speaker compartment when the target earphone is in the worn state, and the detection direction of the infrared distance sensor provided at the second position is downward detection.

In this embodiment, for ease of understanding, as shown in FIG. 13 and FIG. 15. FIG. 13 is a schematic diagram of the arrangement of infrared distance sensors in an example of the present application. The target earphone includes a speaker compartment 3, a behind-ear compartment 1, a connecting bridge 2 connecting the speaker compartment 3 and the behind-ear compartment 1, an infrared distance sensor T1 (i.e., the first distance sensor T1) provided at the first position in the area of the speaker compartment 3, and an infrared distance sensor T2 (i.e., the first distance sensor T2) provided at the second position in the area of the speaker compartment 3, where the first position and the second position are arranged opposite to each other. FIG. 15 is a schematic diagram of an infrared distance detection scenario when the target earphone is in a worn state in an example of the present application. The first position is the upper end position of the speaker compartment 3 when the target earphone is in the worn state, and the detection direction of the infrared distance sensor T1 provided at the first position is upward detection. The second position is the lower end position of the speaker compartment 3 when the target earphone is in the worn state, and the detection direction of the infrared distance sensor T2 provided at the second position is downward detection.

In a possible implementation manner, as shown in FIG. 4, determining the wearing position corresponding to the target earphone according to the three-axis acceleration information and the detection distance information includes:
Step C10: determining a component direction of the three-axis acceleration information in a vertical direction;
Step C20: determining a first distance detected by the infrared distance sensor at the first position and a second distance detected by the infrared distance sensor at the second position;
Step C30: determining wearing posture information corresponding to the target earphone according to the first distance, the second distance, and the component direction;
Step C40: determining the wearing position corresponding to the target earphone according to the wearing posture information.

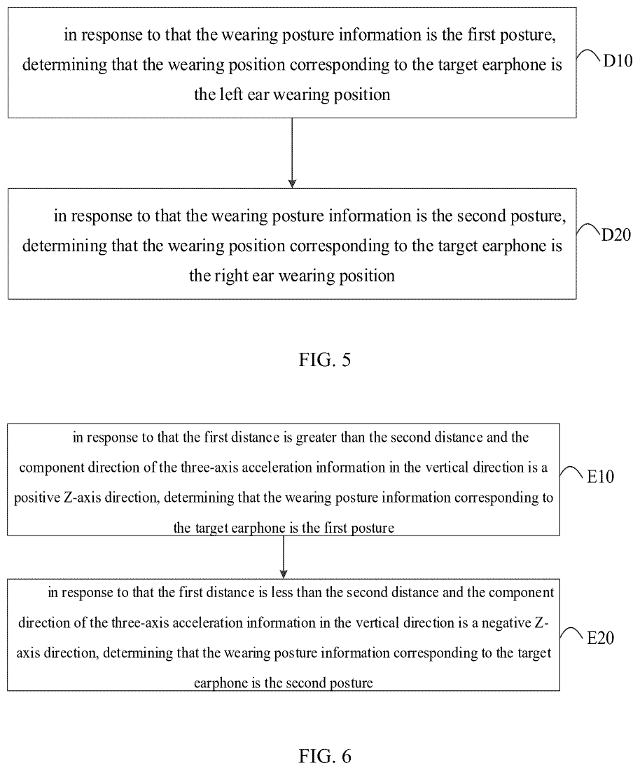

Exemplarily, as shown in FIG. 5, determining the wearing position corresponding to the target earphone according to the wearing posture information includes:
Step D10: in response to that the wearing posture information is the first posture, determining that the wearing position corresponding to the target earphone is the left ear wearing position;
Step D20: in response to that the wearing posture information is the second posture, determining that the wearing position corresponding to the target earphone is the right ear wearing position.

As shown in FIG. 11, FIG. 11 is a schematic diagram of the wearing posture of the clip-on earphone in a worn state from one perspective (viewed from the top of the head). The two individual earphones (the first earphone and the second earphone) are identical, and the user does not need to manually distinguish the left and right ears and can wear them randomly. The earphone will automatically distinguish the left and right sides according to the wearing position of the user and configure the left and right channels. Regardless of the posture of the user's head when wearing the earphone (including upright, lying, and inverted postures), the method for matching left and right channels of the earphone of the embodiment of the present application can realize an automatic detection solution for the left and right channels of the open earphone, facilitating the user's wearing and use. The user no longer needs to distinguish the left and right sides and can take and wear the earphone blindly, effectively ensuring the stability and robustness of the method for matching left and right channels of the earphone of the embodiment of the present application.

In an embodiment, an acceleration sensor may be provided in the behind-ear compartment, and coordinate calibration is performed according to the normal wearing posture during factory shipment. For example, the same coordinate calibration is performed for each individual earphone, and the Z-axis is calibrated to point upward in the normal wearing posture. It is defined that when the earphone is normally worn, if the Z-axis is detected to point upward, it is the left channel (as shown in the side view of the left ear wearing in FIG. 14); when the earphone is worn, if the Z-axis is detected to point downward, it is the right channel (as shown in the side view of the right ear wearing in FIG. 14). When the user wears the earphones in a correct posture, one earphone will have the Z-axis pointing upward and the other will have the Z-axis pointing downward, completing the left and right channel configuration. After the clip-on earphone is shipped from the factory, the left and right channel identification needs to be completed in conjunction with the wearing detection function based on the acceleration sensor data of the earphone.

In this embodiment, the first posture is different from the second posture. It can be understood that the second posture is formed by reversing the first posture by 180 degrees or approximately 180 degrees. As shown in FIG. 14: the left figure in FIG. 14 shows the first posture corresponding to the target earphone worn on the left ear, and the right figure in FIG. 14 shows the second posture corresponding to the target earphone worn on the right ear. The target earphone is either the first earphone or the second earphone.

The first distance refers to the distance detected by the infrared distance sensor provided at the first position, and the second distance refers to the distance detected by the infrared distance sensor provided at the second position.

In this embodiment, when the target earphone is worn on the left ear instead of the right ear, its posture will be reversed. For ease of description, the infrared distance sensor provided at the first position is referred to as a first distance sensor, and the infrared distance sensor provided at the second position is referred to as a second distance sensor. If the target earphone is worn on the left ear, the first distance detected by the first distance sensor from the first ear part is a first distance, and the second distance detected by the second distance sensor from the first ear part is a second distance; then, when the target earphone is worn on the right ear, due to the reversed posture of the target earphone (by approximately 180 degrees), the distance detected by the first distance sensor from the first ear part will be converted to the second distance or approximately the second distance, and the distance detected by the second distance sensor from the first ear part will be converted to the first distance or approximately the first distance. Therefore, the change information of the detection distance of the infrared distance sensor can be used to identify the wearing posture to a certain extent, and further identify whether the earphone is worn on the left ear or the right ear through the wearing posture. It should be noted that the first distance is different from the second distance.

The mapping relationship between the combination of detection distance information and three-axis acceleration information and wearing position information may be pre-stored in the target earphone or in a cloud server registered and logged in with the target earphone.

For ease of understanding, in an embodiment, as shown in FIG. 13 and FIG. 15, FIG. 13 is a schematic diagram of the arrangement of infrared distance sensors in an example of the present application. The target earphone includes a speaker compartment 3, a behind-ear compartment 1, a connecting bridge 2 connecting the speaker compartment 3 and the behind-ear compartment 1, an infrared distance sensor T1 (i.e., the first distance sensor T1) provided at the first position in the area of the speaker compartment 3, and an infrared distance sensor T2 (i.e., the first distance sensor T2) provided at the second position in the area of the speaker compartment 3, where the first position and the second position are arranged opposite to each other. FIG. 15 is a schematic diagram of an infrared distance detection scenario when the target earphone is in a worn state in an example of the present application. The mapping relationship stored in the target earphone or the cloud server registered and logged in with the target earphone is: if the first distance detected by the first distance sensor T1 in the detection distance information falls within a first distance range, the second distance detected by the second distance sensor T2 falls within a second distance range, and the component direction of the three-axis acceleration information in the vertical direction is the positive Z-axis direction, the corresponding wearing position information is the left ear wearing position; and if the first distance detected by the first distance sensor T1 in the detection distance information falls within the second distance range, the second distance detected by the second distance sensor T2 falls within the first distance range, and the component direction of the three-axis acceleration information in the vertical direction is the negative Z-axis direction, the corresponding wearing position information is the right ear wearing position. Based on the stored mapping relationship, it is convenient to determine the wearing position corresponding to the target earphone according to the detection distance information and the three-axis acceleration information. It should be noted that the first distance range is different from the second distance range. Those skilled in the art can set the first distance range and the second distance range according to actual conditions, which are not specifically limited in this embodiment. It can be understood that in the infrared distance detection scenario of the example in FIG. 15, the first distance range is constructed based on the distance d (i.e., the first distance range may be an interval obtained by taking the distance d as the center and floating up and down by a preset value), and the second distance range is constructed based on zero (i.e., the first distance range may be an interval obtained by taking zero as the minimum value and floating upward by a preset value). The preset value should be set as small as possible to match the scenario where the second distance sensor T2 is in contact with the earlobe in FIG. 15; in an example, the preset value is less than or equal to 0.1 mm.

The embodiment of the present application integrates the three-axis acceleration information and detection distance information of the target earphone to adjust the channel of the speaker of the target earphone, so that the channel of the target earphone matches the wearing position. This ensures that the left channel corresponds to the earphone at the left ear wearing position and/or the right channel corresponds to the earphone at the right ear wearing position, thereby realizing automatic matching between left-right channels and left-right ears. This overcomes the inconvenience in the related art where identifiers such as L/R are marked on earphones and manual confirmation is required to avoid wearing them in reverse, improving the usability of the clip-on earphone.

In a possible implementation manner, as shown in FIG. 6, determining the wearing posture information corresponding to the target earphone according to the first distance, the second distance, and the component direction includes:
Step E10: in response to that the first distance is greater than the second distance and the component direction of the three-axis acceleration information in the vertical direction is a positive Z-axis direction, determining that the wearing posture information corresponding to the target earphone is the first posture;
Step E20: in response to that the first distance is less than the second distance and the component direction of the three-axis acceleration information in the vertical direction is a negative Z-axis direction, determining that the wearing posture information corresponding to the target earphone is the second posture.

When the target earphone is worn on the left ear instead of the right ear, its posture will be reversed. For ease of description, the infrared distance sensor provided at the first position is referred to as a first distance sensor, and the infrared distance sensor provided at the second position is referred to as a second distance sensor. If the target earphone is worn on the left ear, the first distance detected by the first distance sensor from the first ear part is a first distance, and the second distance detected by the second distance sensor from the first ear part is a second distance; then, when the target earphone is worn on the right ear, due to the reversed posture of the target earphone (by approximately 180 degrees), the distance detected by the first distance sensor from the first ear part will be converted to the second distance or approximately the second distance, and the distance detected by the second distance sensor from the first ear part will be converted to the first distance or approximately the first distance. Therefore, the change information of the detection distance of the infrared distance sensor can be used to identify the wearing posture to a certain extent, and further identify whether the earphone is worn on the left ear or the right ear through the wearing posture.

For ease of understanding, in another embodiment, as shown in FIG. 15. FIG. 15 is a schematic diagram of an infrared distance detection scenario when the target earphone is in a worn state in an example of the present application. The mapping relationship stored in the target earphone or the cloud server registered and logged in with the target earphone is: if the first distance detected by the first distance sensor T1 in the detection distance information is greater than the second distance detected by the second distance sensor T2, and the component direction of the three-axis acceleration information in the vertical direction is the positive Z-axis direction, the corresponding wearing posture information is the first posture, so that the wearing position corresponding to the target earphone can be determined as the left ear wearing position based on the first posture; and if the first distance detected by the first distance sensor T1 in the detection distance information is less than the second distance detected by the second distance sensor T2, and the component direction of the three-axis acceleration information in the vertical direction is the negative Z-axis direction, the corresponding wearing posture information is the second posture, so that the wearing position corresponding to the target earphone can be determined as the right ear wearing position based on the second posture. Based on the stored mapping relationship, it is convenient to determine the wearing position corresponding to the target earphone according to the detection distance information and the three-axis acceleration information. It can be understood that in the infrared distance detection scenario of the example in FIG. 15, the earphone is most likely worn on the left ear, because the first distance detected by the first distance sensor T1 is significantly greater than the second distance detected by the second distance sensor T2.

The embodiment of the present application provides an open earphone that does not require the user to distinguish the left and right ears when wearing and can automatically identify the left and right channels when worn, avoiding the trouble of the user having to distinguish the left and right earphones before wearing.

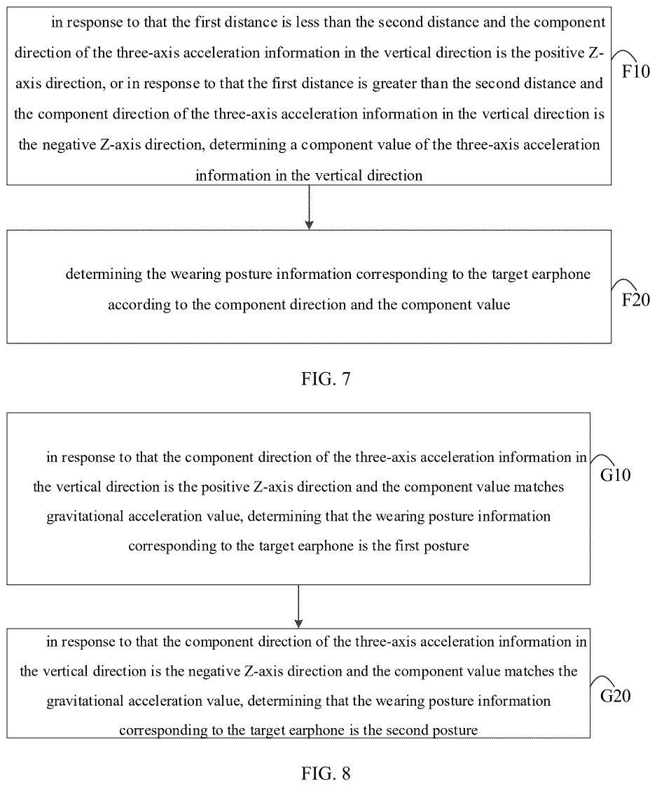

Based on the above embodiment of the present application, in another embodiment of the present application, as shown in FIG. 7, the same or similar content as the above embodiment can be referred to the above description, and will not be repeated hereinafter. On this basis, the method further includes:
Step F10: in response to that the first distance is less than the second distance and the component direction of the three-axis acceleration information in the vertical direction is the positive Z-axis direction, or in response to that the first distance is greater than the second distance and the component direction of the three-axis acceleration information in the vertical direction is the negative Z-axis direction, determining a component value of the three-axis acceleration information in the vertical direction;
Step F20: determining the wearing posture information corresponding to the target earphone according to the component direction and the component value.

Exemplarily, as shown in FIG. 8, determining the wearing posture information corresponding to the target earphone according to the component direction and the component value includes:
Step G10: in response to that the component direction of the three-axis acceleration information in the vertical direction is the positive Z-axis direction and the component value matches gravitational acceleration value, determining that the wearing posture information corresponding to the target earphone is the first posture;
Step G20: in response to that the component direction of the three-axis acceleration information in the vertical direction is the negative Z-axis direction and the component value matches the gravitational acceleration value, determining that the wearing posture information corresponding to the target earphone is the second posture.

In this embodiment, it is known to those skilled in the art that when the user wears the earphone, the user's head is generally in an upright position (the head is rarely in a lying or inverted position). Therefore, the component value in the Z-axis direction generally matches the gravitational acceleration value. Based on this principle, in the embodiment of the present application, if the component direction of the three-axis acceleration information of the target earphone in the vertical direction is the positive Z-axis direction and the component value in the positive Z-axis direction matches the gravitational acceleration value, the wearing posture information corresponding to the target earphone is determined as the first posture; if the component direction of the three-axis acceleration information of the target earphone in the vertical direction is the negative Z-axis direction and the component value in the negative Z-axis direction matches the gravitational acceleration value, the wearing posture information corresponding to the target earphone is determined as the second posture. This further improves the accuracy of identifying the wearing posture of the earphone. The wearing posture is used to determine whether the target earphone is worn on the left ear or the right ear, and the left channel is made to correspond to the earphone at the left ear wearing position and the right channel to correspond to the earphone at the right ear wearing position, thereby realizing automatic matching between left-right channels and left-right ears. This further ensures that the user does not need to distinguish left-right channels before wearing the earphone, and the sound signals of the left and right channels received are always correct no matter how the clip-on earphone is worn.

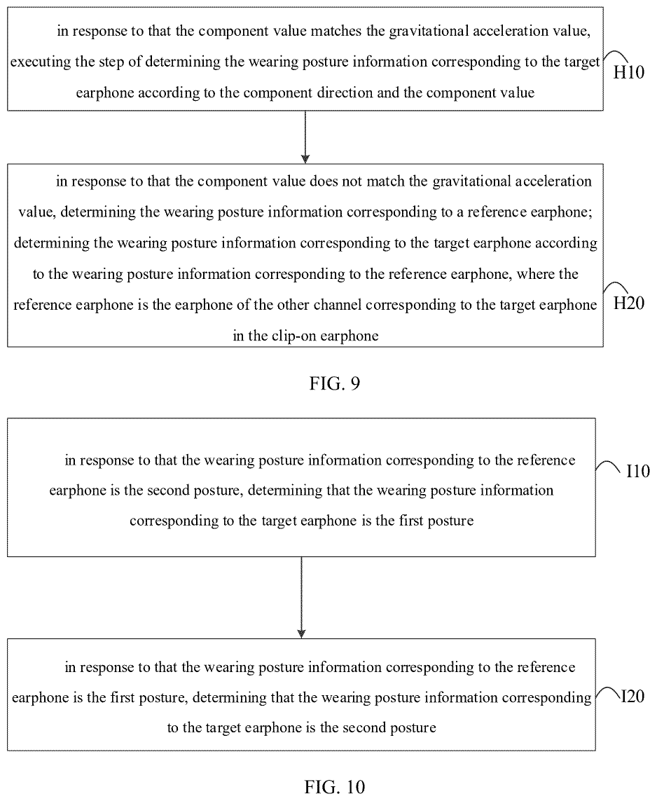

In a possible implementation manner, as shown in FIG. 9, after determining the component value of the three-axis acceleration information in the vertical direction, the method further includes:
Step H10: in response to that the component value matches the gravitational acceleration value, executing the step of determining the wearing posture information corresponding to the target earphone according to the component direction and the component value;
Step H20: in response to that the component value does not match the gravitational acceleration value, determining the wearing posture information corresponding to a reference earphone; determining the wearing posture information corresponding to the target earphone according to the wearing posture information corresponding to the reference earphone, wherein the reference earphone is the earphone of the other channel corresponding to the target earphone in the clip-on earphone.

Exemplarily, as shown in FIG. 10, determining the wearing posture information corresponding to the target earphone according to the wearing posture information corresponding to the reference earphone includes:
Step I10: in response to that the wearing posture information corresponding to the reference earphone is the second posture, determining that the wearing posture information corresponding to the target earphone is the first posture;
Step I20: in response to that the wearing posture information corresponding to the reference earphone is the first posture, determining that the wearing posture information corresponding to the target earphone is the second posture.

There may be cases where even if the acceleration sensor information and detection distance information are integrated for one earphone, the wearing posture information of the target earphone still cannot be effectively detected (e.g., due to special factors such as sensor failure of one earphone). In this case, the wearing posture of the current target earphone can be determined with the assistance of the wearing posture of the other earphone. It is easy to understand that when both earphones are in the worn state, if one earphone is worn on the left ear, the other must be worn on the right ear; and if one earphone is worn on the right ear, the other must be worn on the left ear.

Based on this, in the embodiment of the present application, if the component value does not match the gravitational acceleration value, the wearing posture information corresponding to the reference earphone is determined, and the wearing posture information corresponding to the target earphone is determined according to the wearing posture information corresponding to the reference earphone (where the reference earphone is the earphone of the other channel corresponding to the target earphone in the clip-on earphone). This ensures that even in cases where the wearing posture of one earphone cannot be effectively detected even after integrating the acceleration sensor information and detection distance information, the wearing position of the earphone can still be accurately identified. This facilitates subsequent configuration where the left channel corresponds to the earphone at the left ear wearing position and the right channel corresponds to the earphone at the right ear wearing position, further ensuring accurate automatic matching between left-right channels and left-right ears.

To further facilitate understanding of the technical concept of the present application, a specific embodiment is listed as follows.

As shown in FIG. 11, FIG. 11 is a schematic diagram of the wearing posture of the clip-on earphone in a worn state from one perspective (viewed from the top of the head). The two individual earphones (the first earphone and the second earphone) are identical, and the user does not need to manually distinguish the left and right ears and can wear them randomly. The earphone will automatically distinguish the left and right sides according to the wearing position of the user and configure the left and right channels. Since the user's head is generally in an upright position (rather than lying or inverted) when just wearing the earphone, the method for matching left and right channels of the earphone of the embodiment of the present application can easily realize an automatic detection solution for the left and right channels of the open earphone, facilitating the user's wearing and use. The user no longer needs to distinguish the left and right sides and can take and wear the earphone blindly. In addition, the clip-on earphone of the embodiment of the present application has a simple structure, and the hardware cost for implementing the method for matching left and right channels of the earphone is low.

In an embodiment, an acceleration sensor may be provided in the behind-ear compartment, and coordinate calibration is performed according to the normal wearing posture during factory shipment. For example, the same coordinate calibration is performed for each individual earphone, and the Z-axis is calibrated to point upward in the normal wearing posture. It is defined that when the earphone is normally worn, if the Z-axis is detected to point upward, it is the left channel (as shown in the side view of the left ear wearing in FIG. 14); when the earphone is worn, if the Z-axis is detected to point downward, it is the right channel (as shown in the side view of the right ear wearing in FIG. 14). When the user wears the earphones in a correct posture, one earphone will have the Z-axis pointing upward and the other will have the Z-axis pointing downward, completing the left and right channel configuration. After the clip-on earphone is shipped from the factory, the left and right channel identification needs to be completed in conjunction with the wearing detection function based on the acceleration sensor data of the earphone.

If the user wears the earphones in an abnormal posture (e.g., lying or inverted), the acceleration sensor alone may cause misjudgment, making it impossible to accurately configure the left and right channels.

To solve the problem that the earphone can accurately identify and configure the left and right channels when the user wears it in different postures, infrared distance sensors are provided at the first position and the second position in the speaker compartment.

FIG. 13 is a schematic diagram of the arrangement of infrared distance sensors in an example of the present application, where B represents the speaker compartment and C represents the C-shaped connecting bridge. With reference to FIG. 15, there is one infrared distance sensor at each of the upper and lower symmetric positions of the speaker compartment. FIG. 15 is a schematic diagram of an infrared distance detection scenario when the target earphone is in a worn state in an example of the present application. When the earphone is worn, the bottom of the speaker compartment is in contact with the lower protrusion of the inner contour of the ear; that is, the infrared sensor T2 at the bottom in FIG. 13 is in contact with the ear, so the detected second distance d(T2) is close to zero. The infrared sensor T1 at the upper part is not in contact with the skin and has a relatively long distance from the upper edge of the inner ear contour, so the detected first distance d(T1) is much larger than d(T2).

Similar to the coordinate definition of the acceleration sensor, it is defined that the case where d(T1)>>d(T2) corresponds to the left channel; when d(T2)>>d(T1) is detected (i.e., the earphone is worn on the right ear at this time), it corresponds to the right channel.

When the earphone is taken out of the charging case and worn, the correct configuration of the left and right channels can be completed through the detection of the coordinates by the acceleration sensor and the detection of the contact distance by the infrared sensor. At the same time, the infrared sensor also functions as a wearing detection device. The left and right channel configuration is completed when the earphone is worn, and the left and right ear channels of the user will not change due to changes in the user's head movement during use.

It should be noted that this specific embodiment is only used to understand the technical concept of the present application and does not limit the present application. More simple transformations based on the technical concept of the present application shall fall within the protection scope of the present application.

An embodiment of the present application provides a clip-on earphone. The clip-on earphone includes a memory, a processor, a behind-ear compartment, a speaker compartment, and a connecting bridge connecting the behind-ear compartment and the speaker compartment. The speaker compartment is provided with an acoustic module and an infrared distance sensor, the acoustic module includes a speaker, and the behind-ear compartment is provided with a power module and an acceleration sensor; the power module is used for providing electric energy for the clip-on earphone; the acceleration sensor is used for detecting three-axis acceleration information of the clip-on earphone; the infrared distance sensor is used for detecting detection distance information; the memory is used for storing a program for matching left and right channels of an earphone; the processor is used for executing the earphone left-right channel matching program, and when executing the earphone left-right channel matching program, implementing the steps of the method for matching left and right channels of the earphone in the above embodiment.

The clip-on earphone provided by the present application adopts the method for matching left and right channels of the earphone in the above embodiment, which can solve the technical problem in the related art that manual confirmation of whether the left and right earphones are worn in reverse is required, resulting in poor usability of the clip-on earphone. Compared with the prior art, the beneficial effects of the clip-on earphone provided by the embodiment of the present application are the same as those of the method for matching left and right channels of the earphone provided by the above embodiment, and other technical features of the clip-on earphone are the same as those disclosed in the method of the previous embodiment, which will not be repeated herein.

It should be understood that each part of the present disclosure can be implemented by hardware, software, firmware, or a combination thereof. In the description of the above embodiments, specific features, structures, materials, or characteristics may be combined in any one or more embodiments or examples in an appropriate manner.

The above description is only a specific implementation manner of the present application, but the protection scope of the present application is not limited thereto. Any person skilled in the art can easily think of changes or substitutions within the technical scope disclosed by the present application, which should be covered within the protection scope of the present application. Therefore, the protection scope of the present application should be subject to the protection scope of the claims.

An embodiment of the present application provides a computer-readable storage medium, on which computer-readable program instructions for executing the method for matching left and right channels of the earphone in the above embodiment are stored.

The computer-readable storage medium provided by the embodiment of the present application may be a USB flash drive, but is not limited to a system, device, or device of an electrical, magnetic, optical, electromagnetic, infrared, or semiconductor type, or any combination thereof. More specific examples of the computer-readable storage medium may include, but are not limited to: an electrical connection with one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any appropriate combination of the above. In this embodiment, the computer-readable storage medium may be any tangible medium that contains or stores a program, and the program may be used by or in combination with an instruction execution system, device, or device. The program code contained on the computer-readable storage medium may be transmitted using any appropriate medium, including but not limited to: an electric wire, an optical cable, radio frequency (RF), etc., or any appropriate combination of the above.

The aforementioned computer-readable storage medium may be included in a clip-on earphone; it may also exist independently without being assembled into a clip-on earphone.

The aforementioned computer-readable storage medium carries one or more programs, and when the one or more programs are executed by a clip-on earphone, the clip-on earphone is caused to: when it detects that the target earphone is completely worn, acquiring the three-axis acceleration information detected by the three-axis acceleration sensor and the detection distance information detected by the infrared distance sensor, where the target earphone is the first earphone or the second earphone of the clip-on earphone; adjusting the channel of the speaker of the target earphone according to the three-axis acceleration information and the detection distance information, so that the channel of the target earphone matches the wearing position.

The computer-readable program instructions for executing the operations of the present disclosure may be written in one or more programming languages or a combination thereof. The programming languages include object-oriented programming languages such as Java, Smalltalk, and C++, and also include conventional procedural programming languages such as “C” language or similar programming languages. The program code may be executed entirely on the user's computer, partially on the user's computer, executed as an independent software package, partially on the user's computer and partially on a remote computer, or entirely on the remote computer or server. In the case of a remote computer, the remote computer may be connected to the user's computer through any type of network, including a local area network (LAN) or a wide area network (WAN), or may be connected to an external computer (e.g., connected through the Internet using an Internet service provider).

The flowcharts and block diagrams in the accompanying drawings illustrate the possible system architectures, functions, and operations of the system, method, and computer program product according to various embodiments of the present application. In this regard, each block in the flowchart or block diagram may represent a module, program segment, or part of code, and the module, program segment, or part of code contains one or more executable instructions for implementing the specified logical function. It should also be noted that in some alternative implementations, the functions marked in the blocks may occur in a different order from that marked in the accompanying drawings. For example, two blocks shown in succession may actually be executed substantially in parallel, or they may sometimes be executed in the reverse order, depending on the functions involved. It should also be noted that each block in the block diagram and/or flowchart, and the combination of blocks in the block diagram and/or flowchart, can be implemented by a dedicated hardware-based system that performs the specified functions or operations, or by a combination of dedicated hardware and computer instructions.

The modules described in the embodiments of the present disclosure may be implemented by software or hardware. The name of the module does not constitute a limitation on the module itself in some cases.

The computer-readable storage medium provided by the present application stores computer-readable program instructions for executing the above method for matching left and right channels of the earphone, which can solve the technical problem in the related art that manual confirmation of whether the left and right earphones are worn in reverse is required, resulting in poor usability of the clip-on earphone. Compared with the prior art, the beneficial effects of the computer-readable storage medium provided by the embodiment of the present application are the same as those of the method for matching left and right channels of the earphone provided by the embodiments above, which will not be repeated herein.

An embodiment of the present application further provides a computer program product, including a computer program. When the computer program is executed by a processor, the steps of the method for matching left and right channels of the earphone in the above embodiment are implemented.

The computer program product provided by the present application can solve the technical problem in the related art that manual confirmation of whether the left and right earphones are worn in reverse is required, resulting in poor usability of the clip-on earphone. Compared with the prior art, the beneficial effects of the computer program product provided by the embodiment of the present application are the same as those of the method for matching left and right channels of the earphone provided by the first or second embodiment above, which will not be repeated herein.

The above are only some embodiments of the present application, and are not intended to limit the scope of the present application. Any equivalent structure or equivalent process transformation made by using the description and drawings of the present application, or directly or indirectly applied to other related technical fields, shall similarly be included in the scope of the present application.

What is claimed is:

1. A method for matching left and right channels of an earphone, applied to a clip-on earphone, wherein a target earphone of the clip-on earphone is provided with a three-axis acceleration sensor, and infrared distance sensors are provided at a first position and a second position in a speaker compartment area of the target earphone, the first position is opposite to the second position, the method comprises:
acquiring three-axis acceleration information detected by the three-axis acceleration sensor and detection distance information detected by the infrared distance sensor when it is detected that the target earphone is completely worn, wherein the target earphone is the first earphone or the second earphone of the clip-on earphone; and
adjusting a channel of a speaker of the target earphone according to the three-axis acceleration information and the detection distance information, to make the channel of the target earphone match a wearing position.

2. The method according to claim 1, wherein the adjusting the channel of the speaker of the target earphone according to the three-axis acceleration information and the detection distance information comprises:
determining the wearing position corresponding to the target earphone according to the three-axis acceleration information and the detection distance information; and
adjusting the channel of the speaker of the target earphone based on the wearing position corresponding to the target earphone, to make a left channel correspond to the earphone at a left ear wearing position, and/or a right channel correspond to the earphone at a right ear wearing position.

3. The method according to claim 2, wherein the determining the wearing position corresponding to the target earphone according to the three-axis acceleration information and the detection distance information comprises:
determining a component direction of the three-axis acceleration information in a vertical direction;
determining a first distance detected by the infrared distance sensor at the first position and a second distance detected by the infrared distance sensor at the second position;
determining wearing posture information corresponding to the target earphone according to the first distance, the second distance, and the component direction; and
determining the wearing position corresponding to the target earphone according to the wearing posture information.

4. The method according to claim 3, wherein the determining the wearing posture information corresponding to the target earphone according to the first distance, the second distance, and the component direction comprises:
in response to that the first distance is greater than the second distance and the component direction of the three-axis acceleration information in the vertical direction is a positive Z-axis direction, determining that the wearing posture information corresponding to the target earphone is the first posture; and
in response to that the first distance is less than the second distance and the component direction of the three-axis acceleration information in the vertical direction is a negative Z-axis direction, determining that the wearing posture information corresponding to the target earphone is the second posture.

5. The method according to claim 3, further comprising:
in response to that the first distance is less than the second distance and the component direction of the three-axis acceleration information in the vertical direction is the positive Z-axis direction, or in response to that the first distance is greater than the second distance and the component direction of the three-axis acceleration information in the vertical direction is the negative Z-axis direction, determining a component value of the three-axis acceleration information in the vertical direction; and
determining the wearing posture information corresponding to the target earphone according to the component direction and the component value.

6. The method according to claim 5, wherein the determining the wearing posture information corresponding to the target earphone according to the component direction and the component value comprises:
in response to that the component direction of the three-axis acceleration information in the vertical direction is the positive Z-axis direction and the component value matches gravitational acceleration value, determining that the wearing posture information corresponding to the target earphone is the first posture; and
in response to that the component direction of the three-axis acceleration information in the vertical direction is the negative Z-axis direction and the component value matches the gravitational acceleration value, determining that the wearing posture information corresponding to the target earphone is the second posture.

7. The method according to claim 5, wherein after the determining the component value of the three-axis acceleration information in the vertical direction, the method further comprises:
in response to that the component value matches the gravitational acceleration value, executing the step of determining the wearing posture information corresponding to the target earphone according to the component direction and the component value;
in response to that the component value does not match the gravitational acceleration value, determining the wearing posture information corresponding to a reference earphone; and
determining the wearing posture information corresponding to the target earphone according to the wearing posture information corresponding to the reference earphone, wherein the reference earphone is the earphone of the other channel corresponding to the target earphone in the clip-on earphone.

8. The method according to claim 7, wherein the determining the wearing posture information corresponding to the target earphone according to the wearing posture information corresponding to the reference earphone comprises:
in response to that the wearing posture information corresponding to the reference earphone is the second posture, determining that the wearing posture information corresponding to the target earphone is the first posture; and
in response to that the wearing posture information corresponding to the reference earphone is the first posture, determining that the wearing posture information corresponding to the target earphone is the second posture.

9. The method according to claim 3, wherein the determining the wearing position corresponding to the target earphone according to the wearing posture information comprises:
in response to that the wearing posture information is the first posture, determining that the wearing position corresponding to the target earphone is the left ear wearing position; and
in response to that the wearing posture information is the second posture, determining that the wearing position corresponding to the target earphone is the right ear wearing position.

10. The method according to claim 1, wherein:
the first position is an upper end position of the speaker compartment when the target earphone is in a worn state, and a detection direction of the infrared distance sensor provided at the first position is upward detection; and
the second position is a lower end position of the speaker compartment when the target earphone is in the worn state, and the detection direction of the infrared distance sensor provided at the second position is downward detection.

11. A clip-on earphone, comprising:
a memory;
a processor;
a behind-ear compartment;
a speaker compartment; and
a connecting bridge connecting the behind-ear compartment and the speaker compartment, wherein the speaker compartment is provided with an acoustic module and an infrared distance sensor, the acoustic module comprises a speaker, and the behind-ear compartment is provided with a power module and an acceleration sensor;
the power module is configured for providing electric energy for the clip-on earphone;
the acceleration sensor is configured for detecting three-axis acceleration information of the clip-on earphone;
the infrared distance sensor is configured for detecting detection distance information;
the memory is configured for storing an earphone left-right channel matching program; and
the processor is configured for executing the earphone left-right channel matching program, and when executing the earphone left-right channel matching program, implementing the method for matching left and right channels of the earphone according to claim 1.

12. A non-transitory computer-readable storage medium, wherein a program for implementing the method for matching left and right channels of the earphone is stored on the non-transitory computer-readable storage medium, and when the program for implementing the method for matching left and right channels of the earphone is executed by a processor, the method for matching left and right channels of the earphone according to claim 1 is implemented.
